(19) United States
(12) Patent Application Publication
(10) Pub. No.: US 2016/0263528 A1
(43) Pub. Date: Sep. 15, 2016

(54) MULTI-STAGE IMMERSION MEMBRANE SEPARATION DEVICE AND MEMBRANE SEPARATION METHOD

(71) Applicant: TORAY INDUSTRIES, INC., Chuo-ku,Tokyo (JP)

(72) Inventors: Hiroo Takabatake, Otsu-shi, Shiga (JP); Jihoon Cheon, Iyo-gun, Ehime (JP); Aya Nishio, Otsu-shi, Shiga (JP)

(73) Assignee: Toray Industries, Inc., Chuo-ku, Tokyo (JP)

(21) Appl. No.: 14/777,959

(22) PCT Filed: Mar. 20, 2014
(86) PCT No.: PCT/JP2014/057883

§ 371 Date: Sep. 17, 2015

(30) Foreign Application Priority Data
Mar. 21, 2013 (JP) 2013-058568

(51) Int. Cl. B01D 63/08; C02F 3/12

(52) U.S. Cl. CPC B01D 63/082; C02F 3/1273; B01D 2311/14; B01D 2311/16; B01D 2313/26; B01D 2315/06; B01D 2317/02; C02F 2209/03; C02F 2209/40; C02F 2303/20

(57) ABSTRACT

The present invention provides a submerged type membrane separation device and a membrane separation method that can deal with a temporary increase of a treatment flow rate by taking advantage of the filterability of the constituent separation membranes of the device. In submerged type separation device including a membrane module having stacked therein membrane units in which flat sheet membrane elements having a separation membrane are arranged, a membrane unit having the highest filtration resistance or the highest pure-water permeation resistance is placed at the lowermost stage of the membrane module, thereby setting a high temporary filtration flux for the membrane module as a whole. This makes it possible to deal with a short-term flow rate increase.

### CROSS REFERENCE TO RELATED APPLICATIONS

This is the U.S. National Phase application of PCT International Application No. PCT/JP2014/057883, filed Mar. 20, 2014, and claims priority to Japanese Patent Application No. 2013-058568, filed Mar. 21, 2013, the disclosures of each of these applications being incorporated herein by reference in their entireties for all purposes.

### FIELD OF THE INVENTION

The present invention relates to a multi-stage submerged type membrane separation device in which separation between water and sludge is performed through the use of filtration separation membranes at the occasion of clarification of sewage and industrial effluent, and relates to a membrane separation method using such a membrane separation device.

### BACKGROUND OF THE INVENTION

As to means of clarifying sewage and industrial effluent, there have been known a method of giving enzymes to microorganisms in effluent, a method of mixing water into activated sludge and then performing separation treatment (a membrane bioreactor method, an MBR method for short) and so on. In the membrane bioreactor method in which activated sludge is separated into solids and liquid by the use of separation membranes each having a plurality of pores, the activated sludge is filtrated while the separation membrane surface is cleaned with an air-liquid mixture flow generated in a vertical direction by aeration from beneath the separation membranes for the purpose of suppressing “fouling”, a phenomenon that plugging of the separation membranes is caused by accumulation of activated-sludge components on the separation membrane surface. As an example of a membrane separation device usable in such a membrane bioreactor method, a multi-stage membrane separation device having a plurality of membrane cases (membrane units) stacked vertically in stages has been proposed (Patent Document 1).

It is known that the filtration performance of the vertically stacked membrane units differs from stage to stage, and plugging occurs earlier in lower-stage membrane units. A possible cause of this is that the activated sludge is supplied by aeration from lower to higher stages in a multi-stage membrane separation device using the MBR method, and the filtration at lower-stage membrane units removes only water from sludge, and increases the sludge concentration and the filtration resistance toward the higher stages. This may cause plugging in upper-stage membrane units where the filtration resistance has increased. For stable device operation over extended time periods, a method is disclosed in which apertures are provided between upper and lower stages to accept sludge and prevent plugging in the upper-stage membrane units (Patent Document 2).

In MBR, the aeration from the lowermost portion creates an air-liquid mixture flow while externally drawing sludge from outside of membrane units that are not exposed to aeration. Here, entry of sludge into the membrane unit tends to cause the air-liquid mixture flow to concentrate more toward the center at the lower portion of the membrane unit. The membrane unit at the lowermost stage is thus cleaned only at the central portion of the membrane surface where there is contact with the air-liquid mixture flow, and the pores quickly become plugged in membranes that do not become contact with the air-liquid mixture flow, whereby the effective membrane area is limited. With this being the case, the plugging of the pores is considered to proceed more quickly in the lowermost-stage membrane unit than in upper-stage membrane units.

In the event where the inflow of the water to be treated temporarily increases due to rainfall or other causes, it is considered possible to increase the filtration flux of the MBR device, or to provide a backup MBR device.

### PATENT DOCUMENT

Patent Document 1: JP-A-2000-157848

Patent Document 2: Japanese Patent No. 4107819

### SUMMARY OF THE INVENTION

However, in a multi-stage submerged type membrane separation device intended to deal with a temporary flow rate increase of water to be treated, increasing the filtration flux of the MBR device as in background art promotes membrane plugging, particularly in lower-stage membrane units, and the device fails to filtrate. The provision of a backup MBR device increases the overall size of the device.

Further, because of the notably fast passage of the sludge flow from the lower-stage membrane unit to the upper-stage membrane unit, the method of Patent Document 2 is insufficient to overcome the membrane filtration performance difference between the upper and lower stages, and often fails to inhibit the performance deterioration of the lowermost-stage membrane unit.

Accordingly, an object of the present invention is to provide a multi-stage submerged type membrane separation device that can temporarily increase the overall filtration flux of the device even when membrane plugging proceeds in lower-stage units, and can efficiently operate the membrane separation device as a whole.

Under these circumstances, the present inventors conducted intensive studies, and found that the overall filtration flux of a multi-stage submerged type membrane separation device can be temporarily increased with a membrane module that is configured by combining membrane units having different filtration resistances or pure-water permeation resistances. The present invention was completed on the basis of this finding.

Namely, the present invention includes the following items <1> to <8>.

<1> A multi-stage submerged type membrane separation device including:

a membrane module having a plurality of membrane units stacked vertically in stages, in each of which a plurality of flat sheet membrane elements each having a sheet-shaped separation membrane are arranged;

a water-to-be-treated storage tank in which water to be treated is stored and the membrane module is placed in a state of being submerged in the water to be treated; and

an air diffuser installed beneath the membrane module,

in which the membrane unit placed at the lowermost stage is higher in sludge-filtration resistance or pure-water permeation resistance than any of the membrane units placed at stages higher than the membrane unit placed at the lowermost stage.

<2> The multi-stage submerged type membrane separation device according to <1>, in which the membrane unit placed at the lowermost stage is at least 10% higher in sludge-filtration resistance or pure-water permeation resistance than any other membrane units.
<3> The multi-stage submerged type membrane separation device according to <1> or <2>, in which the membrane unit placed at the lowermost stage is fewer in number of the flat sheet membrane elements installed therein than the any of the membrane units placed at stages higher than the membrane unit placed at the lowermost stage.
<4> The multi-stage submerged type membrane separation device according to any one of <1> to <3>, in which each of the membrane units has a permeate pipeline communicating therewith and sending permeate having passed through the separation membrane, and

the permeate pipeline communicating with the membrane unit placed at the lowermost stage in the membrane module is connected to the permeate pipeline communicating with the any of the membrane units placed at stages higher than the membrane unit placed at the lowermost stage.

<5> The multi-stage submerged type membrane separation device according to <4>, in which a permeate flow rate in the membrane unit placed at the lowermost stage and a permeate flow rate in the any of the membrane units which is placed at a stage higher than the membrane unit placed at the lowermost stage and communicates with the permeate pipeline connected to the permeate pipeline communicating with the membrane unit placed at the lowermost stage are each controlled so that a transmembrane pressure difference of the membrane unit placed at the lowermost stage is almost equalized with a transmembrane pressure difference of the any of the membrane units.
<6> The multi-stage submerged type membrane separation device according to any one of <1> to <5>, in which each of the membrane units has a permeate pipeline communicating therewith and sending permeate having passed through the separation membrane, and

the device further includes a flow rate control means capable of independently controlling a flow rate of permeate sent through the permeate pipeline communicating with the membrane unit placed at the lowermost stage in the membrane module and a flow rate of permeate sent through the permeate pipeline communicating with the any of the membrane units placed at a stage higher than the membrane unit placed at the lowermost stage.

<7> A membrane separation method using a multi-stage submerged type membrane separation device which includes: a membrane module having a plurality of membrane units stacked vertically in stages, in each of which a plurality of flat sheet membrane elements each having a sheet-shaped separation membrane are arranged; a water-to-be-treated storage tank in which water to be treated is stored and the membrane module is placed in a state of being submerged in the water to be treated; and an air diffuser installed beneath the membrane module, in which the membrane unit placed at the lowermost stage is higher in sludge-filtration resistance or pure-water permeation resistance than any of the membrane units placed at stages higher than the membrane unit placed at the lowermost stage.
<8> The membrane separation method according to <7>, in which a flow rate of permeate passing through the separation membrane of the membrane unit placed at the lowermost stage in the membrane module is controlled so as to become lower than a flow rate of permeate passing through the separation membrane of the any of the membrane units placed at a stage higher than the membrane unit placed at the lowermost stage, and controlled so that a difference between these flow rates becomes 10% or below.

The present invention can achieve a higher filtration flux by placing a membrane unit having relatively higher filtration resistance or pure-water permeation resistance against sludge at the lowermost stage of the membrane module. This effective placement of the membrane unit enables effective solid-liquid separation even under a temporarily increased filtration flux condition, and makes it possible to deal with a temporary flow rate increase such as a temporary increase of the flow rate of the water to be treated due to rainfall or other causes. The invention also enables efficient use of membranes in the membrane separation device as a whole, and can reduce the rate of increase of membrane filtration resistance to reduce the frequency of chemical cleaning.

### BRIEF DESCRIPTION OF THE DRAWINGS

FIG. 1 is a perspective view showing a multi-stage submerged type membrane separation device according to an embodiment of the invention.

FIG. 2 is a schematic diagram illustrating a multi-stage submerged type membrane separation device according to one embodiment of the invention.

FIG. 3 is a perspective view showing two flat sheet membrane elements adjacent to each other in the interior of a membrane unit.

FIG. 4 is a schematic diagram illustrating a membrane permeability resistance measurement apparatus.

FIG. 5 is a graph drawn from results of operation testing, in which changes in filtration pressure difference in Example 1 are shown.

FIG. 6 is a graph drawn from results of operation testing, in which changes in filtration pressure difference in Example 2 are shown.

FIG. 7 is a graph drawn from results of operation testing, in which changes in filtration pressure difference in Comparative Example 1 are shown.

FIG. 8 is a graph drawn from results of operation testing, in which changes in filtration pressure difference in Comparative Example 2 are shown.

### DETAILED DESCRIPTION OF EMBODIMENTS OF THE INVENTION

The invention will now be explained in more detail, but the invention should not be construed as being limited to the following embodiments. And in carrying out the invention, changes and modifications can be arbitrarily made without departing from the gist of the invention.

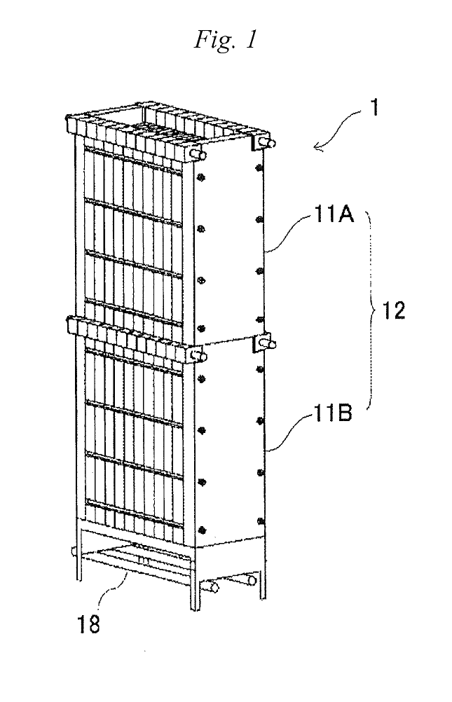

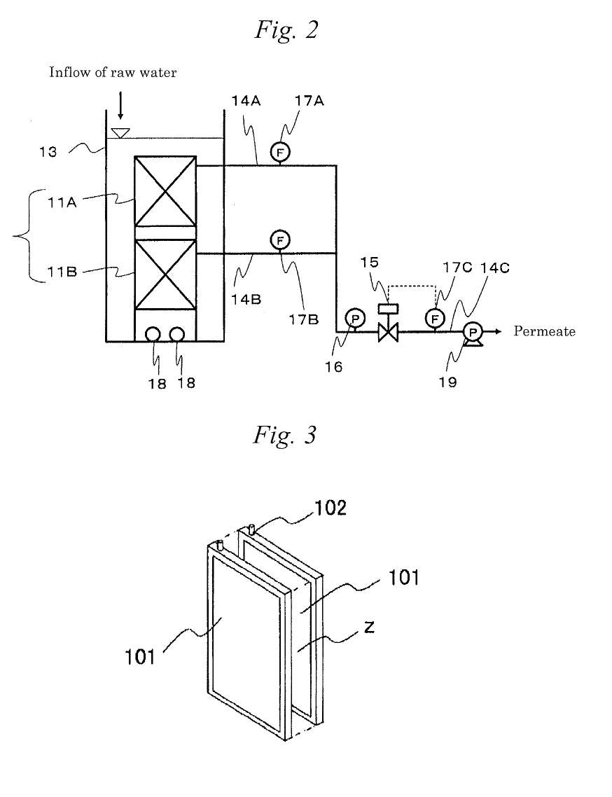

Regarding the multi-stage submerged type membrane separation device according to one or more embodiments of the invention (hereinafter also referred to as “the present device”), the invention is explained below with reference to an exemplification of the multi-stage submerged type membrane separation device having two membrane units as shown in FIGS. 1 and 2.

The multi-stage submerged type membrane separation device shown in FIG. 1 has a membrane module 12 in which two membrane units, a membrane unit 11A and a membrane unit 11B, are placed vertically. As shown in FIG. 2, the membrane module 12 is submerged in water to be treated which is stored in a water-to-be-treated storage tank 13.

In each membrane unit, as shown in FIG. 3, a plurality of flat sheet membrane elements 101 having a sheet-form separation membrane are disposed with a given spacing so that their membrane faces become parallel. Each flat sheet membrane element is an element having a sheet-form separation membrane, and for example, a flat sheet membrane element 101 having a structure that a sheet-form separation membrane is installed on each of the front and back sides of a frame formed e.g. from resin or metal and a permeate outlet communicating with an internal space enclosed by the separation membranes and the frame is provided at the top of the frame, is used. A set of adjacent flat sheet membranes 101 is shown in FIG. 3 (a schematic perspective view). Between flat sheet membranes 101 adjacent to each other is allowed a given spacing (usually 6 to 10 mm), and through this inter-membrane space z is made to flow an upward-moving current of water to be treated, particularly an upward-moving current of mixture of water to be treated and air bubbles generated from an air diffuser 18 described hereinafter.

The membrane units 11A and 11B are communicated with permeate pipelines 14A and 14B, respectively, into which permeates having passed through separation membranes are discharged. Permeate is sent from the permeate outlet 102 of each of flat sheet membrane elements mounted inside each membrane unit into the permeate pipeline. The permeate pipelines 14A and 14B have flowmeters 17A and 17B, respectively, that measure permeate flow rates, and a flowmeter 17C is installed on a permeate pipeline 14C that is in communication with the permeate pipelines 14A and 14B. The flowmeters may be provided in fewer numbers. In this case, it is preferable to install only the flowmeters 17A and 17B, and respectively measure the filtration flow rates of the upper-stage and lower-stage membrane units. When only the flowmeters 17A and 17B are installed, it is possible to provide a control unit, and use the control unit to add the flow rates obtained from the two flowmeters, and control a suction pump based on the added flow rate. Permeates may be discharged from each of the permeate pipelines 14A and 14B. However, this requires the designated pipelines and suction pumps. It is therefore preferable, as shown in FIG. 2, that permeates are gathered by the permeate pipelines 14A and 14B finally communicating with each other and discharged into the outside of the system. In this way, the generated pressure in the membrane filtration can spread by being desirably balanced between the upper-stage and lower-stage membrane units. Further, in the case where the pipelines are finally communicated with each other as shown in FIG. 2, the number of pumps to be installed can be reduced, the space for installation of pumps becomes small, and pump maintenance also becomes easy. A pressure gauge 16 may be installed for each of the permeate pipelines 14A and 14B. However, because the permeate pipelines are in communication with each other, and there is no pressure difference between the upper-stage and lower-stage membrane units, it is sufficient to install the pressure gauge 16 on the permeate pipeline 14C that is provided after the permeate pipelines 14A and 14B are merged, as shown in FIG. 2.

As the driving force for filtration, one example thereof is that the interior of each permeate pipeline is reduced in pressure by operating a filtration pump 19, whereby water to be treated in the water-to-be-treated storage tank is filtrated through separation membranes. The filtrate is taken out to the outside of the system by way of the permeate pipeline. From the viewpoint of enabling filtration without using the energy needed to operate the filtration pump, it is preferable to reduce the pressure inside the permeate pipelines not with the filtration pump but by using a difference in water level of the water-to-be-treated storage tank 13 and a permeate storage tank (not shown). In this case, it is preferable to provide a flow rate control valve 15 on the permeate pipeline 14C that is provided after the permeate pipelines 14A and 14B are merged, and enable membrane filtration at the flow rate set by the flow rate control valve 15 coupled to at least one of the flowmeters 17A, 17B, and 17C.

The air diffuser 18 for generation of air bubbles is installed beneath the membrane module 12 in the water-to-be-treated storage tank 13. By a jet of air issuing from the air diffuser 18, air bubbles are generated in the interior of the water-to-be-treated storage tank 13. An upward-moving air-liquid mixture current generated by air-lift action of a jet of air in addition to air bubbles flows into the lowermost-stage of membrane unit, and further flows into a membrane unit situated in an upper position while newly accompanying mixed liquid in the tank as appropriate. In this way, the separation membrane surfaces are cleaned, whereby transmembrane plugging can be prevented from occurring and further formation of a cake layer likely to adhere to and deposit on separation membrane surfaces can be inhibited. More than one air diffuser 18 may be installed according to the necessity.

In the device of the present invention, a membrane unit having the highest sludge-filtration resistance or the highest pure-water permeation resistance among the plurality of membrane units is preferably placed at the lowermost stage of the membrane module. To be more specific, in the embodiment shown in FIGS. 1 and 2, the membrane unit 11B has the highest sludge-filtration resistance or the highest pure-water permeation resistance.

When a membrane separation device is operated practically, in a membrane module having membrane units stacked vertically in stages, the upper-stage membrane units are relatively less likely to undergo plugging than the lower-stage membrane units. One main reason is that entry of external sludge into the membrane unit tends to create an air-liquid mixture flow that is concentrated more toward the center at the lower portion of the membrane unit. The membrane unit at the lowermost stage is thus cleaned only at the central portion of the membrane surface where there is contact with the air-liquid mixture flow, and the pores quickly become plugged in membranes that do not become contact with the air-liquid mixture flow, whereby the effective membrane area is limited.

Specifically, a membrane unit having high sludge filtration resistance or high pure-water permeation resistance is placed as the lowermost-stage membrane unit where the effective membrane area is limited, and a membrane unit having low sludge filtration resistance or low pure-water permeation resistance is placed at higher stages where the membrane area can be used more effectively. This enables effective use of membranes in the membrane separation device as a whole, and achieves an extended life. The abrupt progression of membrane plugging also can be inhibited even when the flow rate of water to be treated temporarily increases.

The expression of “sludge-filtration resistance of a membrane unit” as used herein refers to ease of making sludge permeate through a separation membrane, or equivalently, the value signifying the degree of membrane clogging (plugging) by filtration, and more specifically, the value obtained by dividing a transmembrane pressure difference (a difference between primary-side pressure and secondary-side pressure) by a permeate flow rate.

In MBR method, filterability can be found by measuring the sludge filtration resistance of a separation membrane using sludge. The sludge filtration resistance of a separation membrane is basically regarded as a sludge filtration resistance of a membrane unit, and is measured by performing filtration with a new or a chemically cleaned fresh membrane unit using the same sludge at the same filtration flux. However, in cases where there is difficulty in making evaluations in the actual setting, one of the flat sheet membrane elements in a membrane unit may be selected, and the value of the sludge filtration resistance of this flat sheet membrane element may be used as a representative value.

The constituents of sludge are not uniform in their permeability through a separation membrane, and hence the order of strength of filtration resistance with respect to a plurality of separation membranes and a membrane unit as an aggregate of separation membranes may depend on the type of sludge. Accordingly, at the occasion of practically installing a submerged type membrane separation device, it is appropriate that the sludge-filtration resistance measurements in the installation place is made on each separation membrane, and separation membranes to be provided as a flat sheet membrane element is chosen on the basis of the thus measured resistance values, and membrane units are assembled as appropriate into a membrane module.

By the way, the expression of “sludge-filtration resistance is high” has the same meaning as the expression of “sludge permeability is low”, and the expression of “sludge-filtration resistance is low” has the same meaning as the expression of “sludge permeability is high”.

In the present invention, the sludge-filtration resistance of a membrane unit is measured according to methods mentioned below. The methods fall into two broad categories: (A) methods of the type which directly determine sludge-filtration resistance of a membrane unit in its entirety and (B) methods of the type which indirectly determine sludge-filtration resistance of a membrane unit by measuring sludge-filtration resistance of a representative membrane contained in the membrane unit and dividing the measured resistance by the area of membranes contained in the membrane unit. From the viewpoint of accurately determining sludge-filtration resistance of a membrane unit in its entirety, the methods of the type (A) are preferred, but it does not matter to adopt the methods of the type (B) from the viewpoint of allowing convenient measurement through the use of a small amount of sludge.

The methods of the type (A) are as follows.

In the present invention, sludge-filtration resistance during the early stages of operation can be important. Accordingly, the sludge-filtration resistance of a membrane unit can be determined as the value obtained by dividing a transmembrane pressure difference soon after the start of using the membrane unit by a permeate flow rate. After the membrane unit has been used, to begin with, clogging of the membrane unit is resolved to the greatest extent practicable, then transmembrane pressure difference and permeate flow rate measurements are carried out, whereby sludge-filtration resistance of the membrane unit can be determined in the same way. As a method for resolving membrane clogging, it is preferable herein to submerge a membrane unit targeted for evaluation into a tank in which an aqueous solution of chemicals is stored in an amount large enough to submerge the membrane unit in the solution (This tank may be a tank different from the water-to-be treated storage tank 13, or it may be the water-to-be-treated storage tank 13 to which an aqueous solution of chemicals is added after removal of sludge accumulated therein). Herein, the submersion time is desirably 2 hours or longer, more desirably 4 hours or longer, and most desirably 10 hours or longer. According to determination of the composition of matter causing membrane clogging, the aqueous solution of chemicals may be prepared as appropriate whenever necessary. When the matter causing membrane clogging is organic matter, an aqueous solution containing 4,000 mg/l or more of hypochlorous acid or an aqueous sodium hydroxide solution having pH of 12 or higher can be used appropriately, and when the matter causing membrane clogging is inorganic matter, an aqueous solution containing 0.1% or higher of oxalic acid or an aqueous solution containing 2% or higher of citric acid etc. can be used appropriately. In addition, there may be cases where firm sludge cake is formed between membrane elements. Accordingly, it is appropriate in such cases that the sludge cake is physically eliminated before the foregoing submersion in a solution of chemicals or a stream of a solution of chemicals is made by aeration from the downward region of membrane units during the submersion in the solution of chemicals.

The foregoing method of the type (B) is as follows.

To begin with, representative membranes are cut out from a membrane unit targeted for evaluation. As to the membranes to be cut out, separation membranes are cut out from positions chosen randomly from a membrane element drawn randomly from a plurality of membrane elements contained in a membrane unit. On this occasion, though it is appropriate that the greatest possible number of representative membranes are cut out and evaluations is performed thereon, at least 3 or more, preferably at least 5 or more, further preferably at least 10 or more, representative membranes are cut out, sludge-filtration membrane resistance measurements are made on the cut-out membranes according to the method described below, the average of these measurement values is calculated, and the average value obtained is defined as the sludge-filtration membrane resistance. And the sludge-filtration resistance of the unit is calculated by dividing the thus obtained sludge-filtration membrane resistance by the area of membranes contained in the unit.

The method for performing evaluation of sludge-filtration membrane resistance on the representative cut-out membranes is as follows.

To begin with, membrane conditioning is carried out. Specifically, the membranes are cleaned with chemicals when the membranes have already been used, while when the membranes are not used yet, the separation membranes are submerged in ethanol for 15 minutes, further submerged in water for 2 hours or longer, and then rinsed with pure water. The cleaning with chemicals is carried out by submerging the membranes in an aqueous solution of chemicals similarly to the foregoing submersion cleaning of the membrane unit, and the submersion time herein is preferably 2 hours or longer, more preferably 4 hours or longer, and most preferably 10 hours or longer. The aqueous solution of chemicals may be determined as appropriate at any time with reference to the composition of matter causing membrane clogging, and when the matter causing membrane clogging is organic matter, an aqueous solution containing 4,000 mg/l or more of hypochlorous acid or an aqueous sodium hydroxide solution having pH of 12 or higher can be used appropriately, while when the matter causing membrane clogging is inorganic matter, an aqueous solution containing 0.1% or higher of oxalic acid or an aqueous solution containing 2% or higher of citric acid etc. can be used appropriately.

By carrying out the following experiment on basic filtration of sludge through the use of the membranes having undergone the foregoing conditioning, sludge-filtration membrane resistance is measured. As to the sludge used in measurement, sludge in which the membrane unit has been submerged or is to be submerged is collected and used preferably within one week of going on cold storage. When sludge is difficult to collect, activated sludge from another sewage disposal plant may be used as a substitute for the sludge.

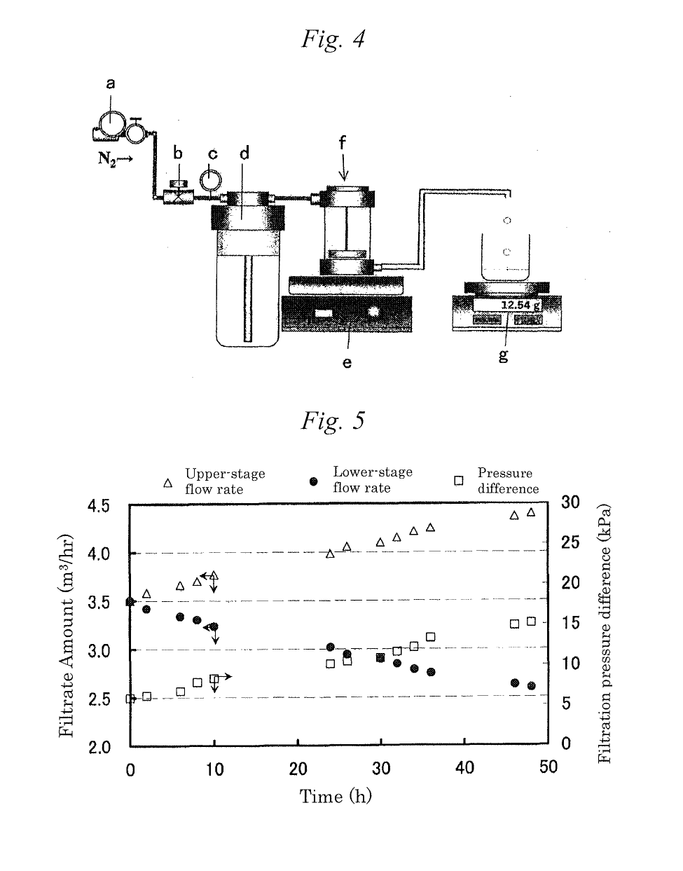

A membrane permeability resistance measurement device (an experimental apparatus for basic filtration of sludge) is configured as shown in FIG. 4 to monitor every unit time with an electronic scale the quantity of permeate passing through an agitation-type cell (Amicon 8010 having an effective membrane area of 4.1 cm², produced by Millipore) under conditions of pressurizing the reserve tank with nitrogen gas (Chia-Chi Ho & A. L. Zyndney, Journal of Colloid and Interface Science, 2002, 232, p. 389). The electronic scale is connected to a computer, and thereafter membrane permeability resistance is calculated from the change in weight with passage of time. Membrane surface flux is given to the membrane surface by rotation of a magnetic stirrer attached to an agitation-type cell, in which the agitating speed in the agitation-type cell is adjusted consistently to 600 rpm, the evaluative temperature is set at 25° C. and the evaluative pressure is set at 20 kPa. Evaluations are performed in the order described below. By the way, the membrane resistance may be calculated through conversion of water temperature into the viscosity of evaluative liquid.

Herein, membrane resistance R is determined by the following expression.

R=(P×t×S)/L

R: Membrane resistance (m²×Pa×s/m³)

P: Evaluative pressure (Pa)

T: Permeation time (s)

L: Permeate quantity (m³)

S: Membrane area (m²)

With continuation of filtration of sludge, the sludge is beginning to adhere to membrane surface, and the membrane resistance R varies with time and is on an upward trend. However, there is a period during which the value of membrane resistance R remains invariant owing to balance between adhesion and peeling caused by agitation. This constant value of membrane resistance is defined as sludge-filtration membrane resistance.

The pure-water permeation resistance of a membrane unit is evaluated by changing the fluid to be filtrated from sludge to pure water or reverse osmosis membrane permeate in the foregoing method for measuring the sludge-filtration resistance.

In the device of embodiments of the present invention, it is appropriate that the sludge-filtration resistance or pure-water permeation resistance of the lowermost-stage membrane unit is at least 10%, preferably at least 15%, particularly preferably at least 30%, most preferably at least 50% higher than the sludge-filtration resistance or pure-water permeation resistance of all of other membrane units, namely those placed in upper positions as compared to the lowermost-stage membrane unit. By adjusting the sludge-filtration resistance or pure-water permeation resistance of the lowermost-stage membrane unit to fall into such a range as mentioned above, more water can be treated through the upper-stage membrane units where the membrane area can be used more effectively, and the balanced use of membranes enables extending life, and a temporary flow rate increase of the water to be treated can be dealt with by setting a high filtration flow rate per unit membrane area.

Examples of a method usable for realizing the foregoing order of membrane units include a method of making the membrane units equal in the number of membrane elements constituting them each and mounting, in a membrane unit to be placed at the lowermost stage, membranes higher in membrane sludge filtration resistance or pure-water permeation resistance than membranes mounted in the other membrane units, and a method of using, in every membrane unit, membranes having almost the same level of membrane sludge filtration resistance or pure-water permeation resistance and decreasing the number of membrane elements in the lowermost-stage membrane unit.

Additionally, separation membranes used therein may be commonly-used porous membranes, and examples thereof include separation membranes made from a (polyvinylidene fluoride)-based resin, a polyacrylonitrile-based resin, a acrylonitrile-styrene copolymer, a polysulfone-based resin, a (polyether sulfone)-based resin and a polyolefin-based resin. Of these separation membranes, the separation membrane made from a (polyvinylidene fluoride)-based resin is preferably used. The thickness of a separation membrane may be in a range of 0.01 mm to 1 mm, and preferably from 0.1 mm to 0.7 mm.

A flat sheet membrane element includes separation membranes and an intake section, and further may include a support plate and a channel member according to the necessity. The separation membranes have no particular restrictions so long as they are in sheet form and have such a structure as to allow water to always pass through them and enter into the flat sheet membrane element. In addition, a support plate may be provided between two separation membranes, whereby the separation membranes may be kept in a flat form. Further, a channel member may be provided between two separation membranes or between a separation membrane and a support plate, whereby a structure may be formed which allows an easy flow of treated water having passed through separation membranes into the intake section while keeping the separation membranes in a flat form. The dimensions of a flat sheet membrane element may be 300 mm×300 mm to 2,000 mm×2,000 mm, preferably 500 mm×1,000 mm to 500 mm×1,500 mm.

It is essential only that the membrane module should include at least two membrane units, and further an aerator may be provided for each membrane unit. However, it is preferred that one aerator is provided for one membrane module. A plurality of membrane units is stacked vertically, but it is appropriate that two or three membrane units are included for each membrane module.

On the other hand, permeate pipelines for sending permeates having passed through separation membranes in membrane units have no particular restrictions so long as they are stable toward water to be treated, treated water and a cleaning solution containing chemicals, and specifically, pipelines made of plastic or metal may be mentioned. Particularly, pipelines made of metal are preferred for ease of submergence.

As to the configuration of permeate pipelines, it is appropriate in terms of installation and maintenance that one permeate pipeline is communicated with one membrane unit.

In the device shown in FIG. 2, two membrane units are placed in the membrane module. It is also possible, however, to place three or more membrane units. In this case, it is preferred that the permeate pipeline communicating with the membrane unit placed at the lowermost stage in the membrane module is connected to at least one permeate pipeline placed upward. Though the number of pumps installed may be the same as the number of permeate pipelines when the pumps are installed for flow rate control, connections between permeate pipelines make it possible to reduce the number of required pumps by the number of connections. Since filtration resistance varies from one membrane unit to another, even when permeates in a plurality of membrane units and permeate pipelines communicating therewith are sucked up with one pump, the membrane units are different from each other in actual suction pressure and flux according to filtration resistance of each individual membrane unit, and therefore flow rate control appropriate to each individual membrane unit becomes possible.

Further, the device of the present invention preferably has a flow rate control means in order to control the flow rate of permeate sent through the communicated permeate pipelines. As the flow rate control means, a filtration pump, a flow rate control valve and the like can be given as examples. From the viewpoint of reduction in energy consumption in particular, it is preferable to control flow rate with a flow rate control valve in a filtration operation that makes use of a water level difference.

It is appropriate that a flow rate control means is installed in the permeate pipeline communicating with the membrane unit placed at the lowermost-stage in the membrane module, and it is also appropriate that another flow rate control means is installed in a permeate pipeline communicating with another membrane unit, namely at least one membrane unit placed upward.

In addition, it is appropriate that the permeate pipeline communicating with the membrane unit placed at the lowermost-stage in the membrane module and the permeate pipeline communicating with a membrane unit placed upward each has a flow rate control means which is capable of controlling independently of each other. This is because, since the membrane unit placed at the lowermost stage is most likely to clog, the balance between the permeate flow rate in the membrane unit placed at the lowermost-stage and the permeate flow rate(s) in the membrane unit(s) placed upward is adjusted, whereby increase in longevity of membrane units can be achieved.

The flow rate control means may be provided for each of the permeate pipelines that are in communication with the membrane units. It is, however, preferable to provide the flow rate control means on the permeate pipeline that is provided after the respective permeate pipelines are merged. This enables exerting the same pressure on each membrane unit, and in the case where a membrane unit having high filtration resistance is placed at the lowermost stage, the applied load on the membrane unit placed at the lowermost stage spreads over other membrane units and naturally becomes smaller to provide a good balance in the membrane module as a whole.

The device of the present invention may have a pressure measuring means for determining the permeate-sucking pressure during filtration in substitution for or in combination with the flow rate control means as described above. It is essential only that the operational pressure difference between the permeate-sucking pressure during the filtration and the pressure during the filtration stop can be determined.

Cases where the operational pressure difference of the permeate having passed through separation membranes of the membrane unit placed at the lowermost stage in the membrane module is greater than a predetermined value mean a state that the membrane unit has high resistance to sludge and low sludge permeability, or equivalently, the membrane is beginning to plug up owing to the clogging.

As to the foregoing predetermined value, depending on the properties of water to be treated, the operational pressure difference is preferably from 10 kPa to 40 kPa, more preferably 20 kPa or below.

In cases where the operational pressure difference increases beyond the predetermined value, it is appropriate to adopt a measure of cleaning the plugged membrane unit with chemicals, or varying the quantity of air diffused or the duration of air diffusion from an air diffuser, or reducing the flow rate of permeate in the membrane unit. Thereby, the operational pressure difference is lowered to the order of 5 to 10 kPa, and filtration operation can be performed favorably.

The term “cleaning with chemicals” as used herein means that a plugged separation membrane is subjected to backwashing from the secondary side of the separation membrane through the use of acid or alkaline chemicals, and examples of chemicals used include sodium hypochlorite, citric acid and oxalic acid. Of these chemicals, sodium hypochlorite and citric acid are preferably used.

In the case of increasing the quantity of air diffused from an air diffuser, the air quantity may be at most 20 NL/min/EL, preferably 8 NL/min/EL or less relative to the normal air quantity 5 NL/min/EL (“NL/min/EL” means “normal liter per minute per element”).

Regarding a time period for air diffusion from an air diffuser, the air diffusion can be carried out intermittently in some cases, but the air diffusion is preferably performed continuously.

Incidentally, the cleaning with chemicals and the increment in quantity of air diffused or the duration of air diffusion vary greatly according to the type, temperature, viscosity and other constitutions of water to be treated, and therefore it is required to select the best conditions and carry out membrane separation under the selected conditions as occasion arises.

In order to deal with cases in which not only the operational pressure difference of the permeate from the lowermost-stage membrane unit decreases below the predetermined value but also the flow rate value or pressure value of the permeate becomes smaller than a predetermined value, or cases in which the difference between the flow rate value or pressure value of permeate from the membrane unit placed at the lowermost stage and the flow rate value or pressure value of the permeate from any of the other membrane units becomes greater than a predetermined value, it is also possible to adopt the same measures as mentioned above, namely a measure of cleaning the lowermost-stage membrane unit with chemicals, or increasing the quantity of air diffused or the duration of air diffusion from the air diffuser, or reducing the flow rate of permeate in the lowermost-stage membrane unit.

The expression of “a difference between pressure values of permeates is greater than a predetermined value” means a state that the membrane unit is becoming high in resistance to sludge and low in sludge permeability, or equivalently, the membrane unit is beginning to plug up owing to clogging. When the permeate pressure difference becomes greater than a predetermined value, plugging proceeds in the membrane unit placed in the lowermost stage, and cannot be solved by cleaning with chemicals or diffused air.

The term “predetermined value” refers to the value which can be determined on a measurement value allowing assessment of filtration pressure under operation, such as a filtration pressure or a filtration pressure difference, in consideration of filtration operation conditions and conditions of sludge and water to be treated.

Further, it is appropriate that membrane separation is conducted under conditions that the flow rate is controlled using a flow rate control means as mentioned above so that the flow rate of permeate obtained by permeation through separation membranes in the membrane unit placed at the lowermost stage of a membrane module becomes smaller than the flow rate of permeate obtained by permeation through separation membranes in at least any one of other separation units, namely, one or more membrane units placed upward. By intentionally reducing the quantity of water passing through the membrane unit placed at the lowermost stage of a membrane module, the time elapsing before the lowermost-stage membrane unit becomes plugged can be extended.

In other words, by adjusting the flow rate in the lowermost-stage membrane unit to be low and the flow rate(s) in the upper-stage membrane unit(s) to be rather high, the time elapsing before the membrane units require cleaning can be made longer, and besides, the timings in cleaning the plurality of membrane units can be adjusted to be synchronized, whereby all the membrane units can be taken out at a time for cleaning and can be subjected to cleaning.

In addition, it is appropriate that a difference between the flow rate of permeate passing through the lowermost-stage membrane unit and the flow rate of permeate passing through one or more of the other membrane units is 10% or smaller. This is because similar permeate pipelines can be used for the lowermost-stage membrane unit and the membrane unit(s) placed upward, whereby not only operational malfunctions due to mistakes in installation can be reduced but also piping resistance can be reduced.

Making an additional remark, the temporary filtration flow rate of the membrane module can be further increased by adjusting the flow rate of a membrane unit placed at a higher stage to be higher and that of a membrane unit placed at a lower stage to be lower, and the longevity of membrane units can be expected.

On the other hand, substitution of a pressure control for the flow rate control means can also produce an effect similar to the above. In this case, it is essential only that the pressure difference between water to be treated and permeate is adjusted to rise somewhat slowly in the membrane unit placed at the lowermost stage, while it is adjusted to rise somewhat rapidly in membrane unit(s) placed upward. And an increase in longevity of membrane units can be expected by adjusting membrane units placed at lower stages to be slower in pressure difference rise and membrane units placed at higher stages to be more rapid in pressure difference rise.

Further, by connecting the permeate pipeline communicating with the membrane unit placed at the lowermost stage to the permeate pipeline communicating with another membrane unit placed upward and carrying out membrane filtration and so on by the use of driving force generated from one and the same suction pump, transmembrane pressure differences of these membrane units can be always kept almost the same. In this case, it also becomes possible to control a transmembrane pressure difference of each individual membrane unit by giving resistance to a flow of permeate through the use of a flow rate control valve or the like provided in each permeate pipeline. And it is appropriate that a difference between the transmembrane pressure differences is adjusted to fall within ±10%. Thereby, not only pump power can be utilized without being wasted, but also a membrane unit in which membrane clogging is in progress comes to be spontaneously reduced in membrane filtration flow rate by the clogging quantity, and well balanced utilization comes to be attained between membrane units.

Although the submerged-type membrane separation device and membrane separation method according to the present invention have been illustrated above with an eye on sludge-containing water to be treated, they can treat not only activated sludge but also river water, lake water, ground water, seawater, sewage, wastewater, effluent from food processing or so on as water to be treated and perform elimination of suspension in the water to be treated, whereby it become possible to utilize them for various purposes, including water purification treatment, wastewater treatment, drinking water production, industrial water production and so on.

### EXAMPLES

The invention will now be illustrated below with reference to examples, but these examples should not be construed as limiting the scope of the invention in any way.

### <Preparation of Separation Membrane>

Polyvinylidene fluoride (PVDF; Kureha Corporation product KF#850) was used as a resin component for a membrane-forming stock solution. In addition, polyoxyethylene sorbitan monostearate, N,N-dimethylformamide (DMF) and H₂O were used as a pore opening agent, a solvent and a nonsolvent, respectively. These ingredients were thoroughly mixed together with stirring under a temperature of 95° C., and membrane-forming stock solutions having the compositions shown in Table 1, respectively, were prepared.

A base material used for separation membranes was rectangle-shaped nonwoven fabric which was made from polyester fibers and had a density of 0.42 g/cm³, a width of 50 cm and a length of 150 cm. Then, each of the membrane-forming stock solutions was cooled to 30° C., and applied to the base material. Immediately after the application, the resulting material was immersed in 20° C. pure water for 5 minutes, and further immersed in 90° C. hot water for 2 minutes, whereby N,N-dimethylformamide as solvent and polyoxyethylene sorbitan monostearate as the pore opening agent were flushed out. In this manner, composite separation membranes 1 to 3 were prepared.

### <Sludge-Filtration Resistance and Pure-Water Permeation Resistance Measurements>

By the use of the above-mentioned method for carrying out experimentation of sludge-filtration resistance, sludge-filtration resistance measurements were performed on each of the separation membranes 1 to 3 prepared according to their respective compositions and the method mentioned above.

As sludge to be used in sludge-filtration resistance measurements on the separation membranes, a sludge solution was prepared by acclimatizing sludge collected from a sewage disposal plant for about one year on a dextrin culture medium (constituted of 12 g/L of dextrin, 24 g/L of polypeptone, 7.2 g/L of ammonium sulfate, 2.4 g/L of monopotassium phosphate, 0.9 g/L of sodium chloride, 0.3 g/L of magnesium sulfate heptahydrate and 0.4 g/L of calcium chloride dihydrate) on condition that the BOD volumetric load was 1 g-BOD/L/day and the water residence time was one day, and further the sludge solution (MLSS: 15.17 g/L) was diluted with reverse osmosis membrane filtrate so that the MLSS was reduced to 1 g/L. By the use of the thus diluted sludge solution, paper filtration testing was carried out. Therein, it was found that, when 50 mL of the diluted sludge solution was filtrated through a paper filter having a pore size of 1 μm (No. 5C) at a temperature of 20° C. over 5 minutes, the quantity of permeate obtained was 18.9 mL. The viscosity of the diluted sludge solution was measured with a viscometer (VT-3E, Rotor No. 4, a product of RION Co., Ltd.) and found to be 1.3 mPas (20° C.).

Each separation membrane was immersed in ethanol first, then in water in place of the ethanol, and further rinsed with pure water for about 5 minutes. After removal of a reserve tank, an agitation-type evaluation cell was filled with the diluted sludge solution (15 g) in a state that the membrane after evaluation was set in the cell, and filtration of a predetermined amount (7.5 g) of the diluted sludge solution was carried out. After the certain amount of filtration, the membrane resistance came to be held almost constant for the last 20 seconds during the filtration of the sludge. The resistance calculated from this filtrate amount was thus defined as sludge filtration resistance R. Likewise, pure-water permeation resistance R was determined by using pure water instead of sludge. Results obtained by these experiments are shown in Table 2. As the separation membranes 1 to 3, membranes differing from one another in sludge filtration resistance were obtained.

### <Preparation of Flat Sheet Membrane Element>

Flat sheet membrane elements were made using the separation membranes 1 to 3 differing in sludge-filtration resistance, respectively.

Each of the flat sheet membrane elements was made in principle on the basis of Element TSP-50150, a product of Toray Industries, Inc. Each flat sheet membrane element had a structure that an intake nozzle was installed at the top of the element and separation membranes were made to adhere to both sides of a supporting plate having dimensions of 1,600 mm×500 mm, and the area of separation membranes was 1.4 m². Each flat sheet membrane element was made by cutting out two sheets of each individual separation membrane to suite the size of the element and putting the sheets on both sides of the supporting plate of the element, respectively.

### <Preparation of Membrane Unit>

TMR140, a product of Toray Industries, Inc., was used as a membrane unit. To begin with, the membrane unit was constructed from flat sheet membrane elements using separation membranes of the same kind chosen from the foregoing separation membranes, and then a membrane module was prepared by stacking up an air diffusing block, a lower-stage membrane unit, an intermediate block and an upper-stage membrane unit in this order. As the lower-stage membrane unit and the upper-stage membrane unit, membrane units constructed by incorporating therein 20 sheets of the above-mentioned flat sheet membrane elements per membrane unit were used.

### <Configuration of Membrane Module>

Membrane separation testing was carried out by using a submerged-type membrane separation device including a membrane module equipped with two membrane units, one of which was placed at the lower stage and relatively high in sludge-filtration resistance and pure-water permeation resistance and the other of which was placed at the upper stage and relatively low in sludge-filtration resistance and pure-water permeation resistance. A difference in filtration resistance between the lower-stage membrane unit and the upper-stage membrane unit was calculated by the following expression.

Sludge-filtration resistance difference=(Sludge-filtration resistance of membranes used in the lower-stage membrane unit/membrane area of the membrane unit−sludge-filtration resistance of membranes used in the upper-stage membrane unit/membrane area of the membrane unit)×100÷ (sludge-filtration resistance of membranes used in the lower-stage membrane unit/membrane area of the membrane unit).

Pure-water permeation resistance difference=(Pure-water permeation resistance of membranes used in the lower-stage membrane unit/membrane area of the membrane unit−pure-water permeation resistance of membranes used in the upper-stage membrane unit/membrane area of the membrane unit)×100÷ (pure-water permeation resistance of membranes used in the lower-stage membrane unit/membrane area of the membrane unit)

Membrane unit compositions of the membrane modules used, namely the membrane modules 1 to 4, and filtration resistance differences of these membrane modules are shown in Table 3.

### <Filtration Operation Test on Membrane Module>

Test conditions were as follows.

Domestic wastewater was treated under the conditions shown all together in Table 4. Domestic wastewater was introduced into a denitrification tank by means of a raw-water feed pump and subjected to treatment, and the resulting liquid was introduced into a membrane bioreactor tank. In the membrane bioreactor tank, an aerobic condition was maintained by aeration supplied from a membrane module, and filtration of treated water was performed. Incidentally, the sludge in the membrane bioreactor tank was drawn out periodically by means of a sludge drawing pump in order to retain MLSS concentration.

The filtration operation of each membrane module was carried out in a constant flow-rate operation mode. The filtration flow rate in a rated operation was 56 m³/d. However, the filtration flow rate was temporarily increased to 168 m³/d in filtration operations performed in Examples and Comparative Examples. In Examples and Comparative Examples, experiments were conducted on a rainy day.

### Example 1

In Example 1, experiments were conducted by using the membrane module 1 with a device configured as shown in FIG. 2. The experiments were carried out under the controlled filtration flow rate of the membrane module. A flowmeter was provided for each of the upper-stage and lower-stage membrane units, and a pressure gauge, a flow rate control valve, a flowmeter, and a filtration pump were provided on the permeate pipeline that was provided after the permeate pipelines from the upper-stage and lower-stage membrane units were merged. The operation was initially performed with the filtration pump, and was later switched with the flow rate control valve, before inactivating the filtration pump. Here, the filtration operation was performed with the filtration pump and the flow rate control valve coupled to the flowmeter to make the flow rate constant. The filtration flow rate was 168 m³/d, and a filtration cycle of 9-minute filtration and 1-minute standstill was repeated. The filtration pressure difference was worked out by subtracting the filtration pressure after a lapse of 50 seconds from the end of the filtration from the filtration operation pressure after a lapse of 8 minutes from the start of filtration operation.

The filtration operation was started in a situation that the filtration pressure difference was on the order of 5 kPa to 6 kPa and made to continue for one month under the filtration operation conditions specified above. Developments since the filtration operation was started are shown in FIG. 5. The filtration operation was considered stable when the filtration pressure difference remained 25 kPa or less until hour 48 of the filtration operation.

The experiment results revealed that, as shown in FIG. 5, the filtration pressure differences in the upper-stage and lower-stage membrane units were all below the upper limit (25 kPa) of filtration pressure difference that allows for stable filtration operation, and a temporary stable operation is considered possible even under high filtration fluxes.

### Example 2

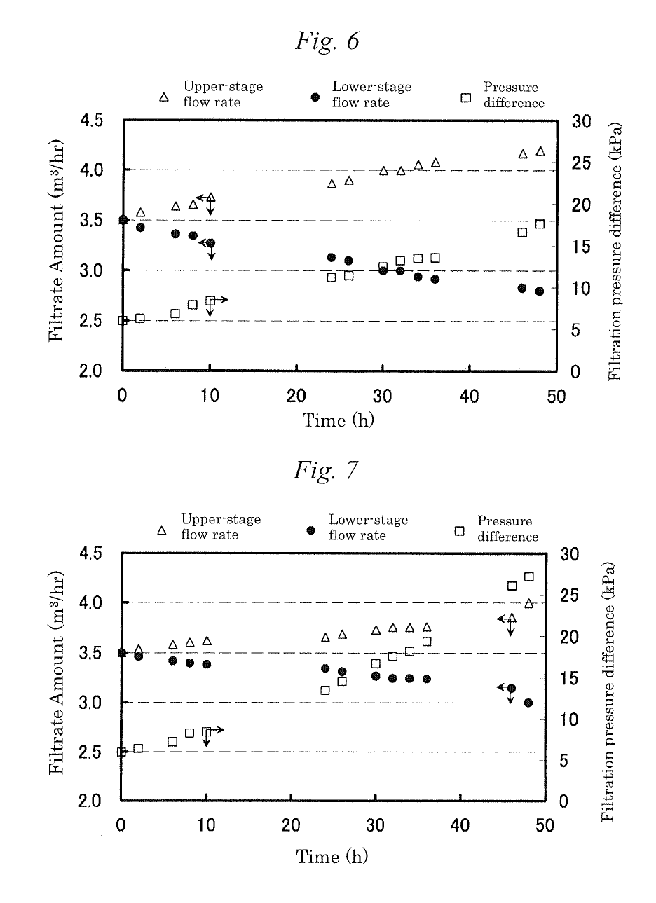

Experiments were carried out in the same manner as in Example 1, except that the membrane module 2 was used. The experiment results revealed that, as shown in FIG. 6, the filtration pressure differences in the upper-stage and lower-stage membrane units were all below the upper limit (25 kPa) of filtration pressure difference that allows for stable filtration operation, and a temporary stable operation is considered possible even under high filtration fluxes.

### Comparative Example 1

Experiments were carried out in the same manner as in Example 1, except that the membrane module 3 was used. The experiment results revealed that, as shown in FIG. 7, the filtration pressure differences in the membrane module were above the upper limit (25 kPa) of filtration pressure difference that allows for stable filtration operation, and a stable operation was not possible under high filtration fluxes.

### Comparative Example 2

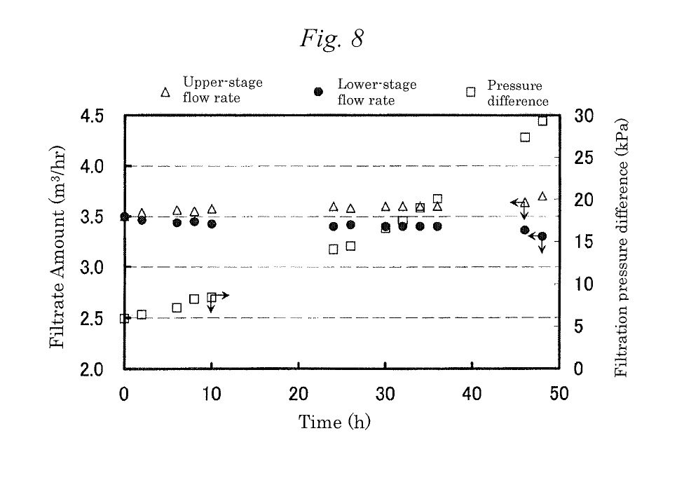

Experiments were carried out in the same manner as in Example 1, except that the membrane module 4 was used. The experiment results revealed that, as shown in FIG. 8, the filtration pressure differences in the membrane module were above the upper limit (25 kPa) of filtration pressure difference that allows for stable filtration operation, and a stable operation was not possible under high filtration fluxes.

TABLE 1

| | | | N,N- | |
|---|---|---|---|---|
| | | Polyoxyethylene | dimethyl- | |
| | Polyvinylidene | sorbitan | formamide | |
| | fluoride | monostearate | (DMF) | H₂O |
| | (PVDF, wt %) | (wt %) | (wt %) | (wt %) |
| Membrane 1 | 16.6 | 8.4 | 72.0 | 3.0 |
| Membrane 2 | 16.5 | 8.5 | 72.0 | 3.0 |
| Membrane 3 | 16.3 | 8.7 | 72.0 | 3.0 |

TABLE 2

| | | Pure-Water Permeation |
|---|---|---|
| | Sludge-Filtration Resistance R | Resistance R |
| | (10⁷ m² · Pa · s/m³) | (10⁶ m² · Pa · s/m³) |
| Membrane 1 | 38.9 | 30.3 |
| Membrane 2 | 36.7 | 29.5 |
| Membrane 3 | 33.0 | 26.0 |

TABLE 3

| | | | Sludge- | Pure-Water |
|---|---|---|---|---|
| | Membranes | Membranes | Filtration | Permeation |
| | Used in Upper- | Used in Lower- | Resistance | Resistance |
| | Stage | Stage | Difference | Difference |
| | Membrane Unit | Membrane Unit | (%) | (%) |
| Membrane | Membrane 3 | Membrane 1 | 15.2 | 14.2 |
| Module 1 | | | | |
| Membrane | Membrane 3 | Membrane 2 | 10.1 | 11.9 |
| Module 2 | | | | |
| Membrane | Membrane 3 | Membrane 3 | 0 | 0 |
| Module 3 | | | | |
| Membrane | Membrane 2 | Membrane 3 | −11.2 | −13.5 |
| Module 4 | | | | |

TABLE 4

| Type of raw water | Domestic wastewater |
|---|---|
| Water quality of raw water | Biological oxygen demand: 200 mg/L |
| (average value) | Total nitrogen: 45 mg/L |
| | Total phosphorus: 8 mg/L |
| Amount of treated water | 56 m³/d |
| Capacity of biological | Denitrification tank: 6.8 m³ |
| treatment tank | Membrane bioreactor tank: 6.8 m³ |
| | Total: 13.6 m³ |
| Hydraulic residence time | Denitrification tank: 3 hours |
| | Membrane bioreactor tank: 3 hours |
| | Total: 6 hours |
| Activated sludge | MLSS in membrane bioreactor tank: 8,000 to 15,000 mg/L |
| condition | DO in membrane bioreactor tank: 0.5 to 2.0 mg/L |
| Amount of | 168 m³/d |
| circulated sludge | (three times larger than the amount of water to be treated) |
| Temperature of | 20° C. to 25° C. |
| water to be treated | |
| Air diffuser | Micro-bubbles diffuser tube, |
| | made by MISUZU Industry Co., Ltd. |
| | Cylindrical air diffuser tube made of rubber: 6 pieces |
| Amount of diffused air | 0.3 m³/min |
| | 8 NL/min/EL × 40 EL |

While the invention has been described above in detail and with reference to specific embodiments thereof, it will be apparent to one skilled in the art that various changes and modifications can be made thereto without departing from the spirit and scope of the invention. This application is based on Japanese Patent Application No. 2013-058568 filed on Mar. 21, 2013, the contents of which are incorporated herein by reference.

The submerged type membrane separation device according to the present invention can temporarily increase the overall filtration flux of the device even when membrane plugging proceeds in lower-stage membrane units, and make it possible to deal with a temporary abrupt flow rate increase such as a temporary increase of the flow rate of the water to be treated due to rainfall or other causes.

With regard to the device according to the present invention, it is expected that not only sludge but also river water, lake water, groundwater, seawater, sewage, wastewater, food processing effluent and the like are applicable as water to be treated and membrane separation thereof can be performed.

### DESCRIPTION OF REFERENCE NUMERALS AND SIGNS

1: Multi-stage submerged type membrane separation device
11A, 11B: Membrane unit
12: Membrane module
13: Water-to-be-treated storage tank
14A, 14B, 14C: Permeate pipeline
15: Flow rate control valve
16: Pressure gauge
17A, 17B, 17C: Flowmeter
18: Air diffuser
19: Filtration pump
101: Flat sheet membrane element
102: Permeate outlet
a: Pressure controller
b: Valve
c: Pressure gauge
d: Reserve tank for feed water
e: Magnetic stirrer
f: Membrane filtration unit
g: Electronic scale

1. A multi-stage submerged type membrane separation device comprising:
a membrane module having a plurality of membrane units stacked vertically in stages, in each of which a plurality of flat sheet membrane elements each having a sheet-shaped separation membrane are arranged;
a water-to-be-treated storage tank in which water to be treated is stored and the membrane module is placed in a state of being submerged in the water to be treated; and
an air diffuser installed beneath the membrane module,
wherein the membrane unit placed at the lowermost stage is higher in sludge-filtration resistance or pure-water permeation resistance than any of the membrane units placed at stages higher than the membrane unit placed at the lowermost stage.

2. The multi-stage submerged type membrane separation device according to claim 1, wherein the membrane unit placed at the lowermost stage is at least 10% higher in sludge-filtration resistance or pure-water permeation resistance than any other membrane units.

3. The multi-stage submerged type membrane separation device according to claim 1, wherein the membrane unit placed at the lowermost stage is fewer in number of the flat sheet membrane elements installed therein than the any of the membrane units placed at stages higher than the membrane unit placed at the lowermost stage.

4. The multi-stage submerged type membrane separation device according to claim 2, wherein the membrane unit placed at the lowermost stage is fewer in number of the flat sheet membrane elements installed therein than the any of the membrane units placed at stages higher than the membrane unit placed at the lowermost stage.

5. The multi-stage submerged type membrane separation device according to claim 1, wherein each of the membrane units has a permeate pipeline communicating therewith and sending permeate having passed through the separation membrane, and
the permeate pipeline communicating with the membrane unit laced at the lowermost stage in the membrane module is connected to the permeate pipeline communicating with the any of the membrane units placed at stages higher than the membrane unit placed at the lowermost stage.

6. The multi-stage submerged type membrane separation device according to claim 2, wherein each of the membrane units has a permeate pipeline communicating therewith and sending permeate having passed through the separation membrane, and
the permeate pipeline communicating with the membrane unit placed at the lowermost stage in the membrane module is connected to the permeate pipeline communicating with the any of the membrane units placed at stages higher than the membrane unit placed at the lowermost stage.

7. The multi-stage submerged type membrane separation device according to claim 3, wherein each of the membrane units has a permeate pipeline communicating therewith and sending permeate having passed through the separation membrane, and
the permeate pipeline communicating with the membrane unit placed at the lowermost stage in the membrane module is connected to the permeate pipeline communicating with the any of the membrane units placed at stages higher than the membrane unit placed at the lowermost stage.

8. The multi-stage submerged type membrane separation device according to claim 5, wherein a permeate flow rate in the membrane unit placed at the lowermost stage and a permeate flow rate in the any of the membrane units which is placed at a stage higher than the membrane unit placed at the lowermost stage and communicates with the permeate pipeline connected to the permeate pipeline communicating with the membrane unit placed at the lowermost stage are each controlled so that a transmembrane pressure difference of the membrane unit placed at the lowermost stage is almost equalized with a transmembrane pressure difference of the any of the membrane units.

9. The multi-stage submerged type membrane separation device according to claim 6, wherein a permeate flow rate in the membrane unit placed at the lowermost stage and a permeate flow rate in the any of the membrane units which is placed at a stage higher than the membrane unit placed at the lowermost stage and communicates with the permeate pipeline connected to the permeate pipeline communicating with the membrane unit placed at the lowermost stage are each controlled so that a transmembrane pressure difference of the membrane unit placed at the lowermost stage is almost equalized with a transmembrane pressure difference of the any of the membrane units.

10. The multi-stage submerged type membrane separation device according to claim 7, wherein a permeate flow rate in the membrane unit placed at the lowermost stage and a permeate flow rate in the any of the membrane units which is placed at a stage higher than the membrane unit placed at the lowermost stage and communicates with the permeate pipeline connected to the permeate pipeline communicating with the membrane unit placed at the lowermost stage are each controlled so that a transmembrane pressure difference of the membrane unit placed at the lowermost stage is almost equalized with a transmembrane pressure difference of the any of the membrane units.

11. The multi-stage submerged type membrane separation device according to claim 1, wherein each of the membrane units has a permeate pipeline communicating therewith and sending permeate having passed through the separation membrane, and
the device further comprises a flow rate control means capable of independently controlling a flow rate of permeate sent through the permeate pipeline communicating with the membrane unit placed at the lowermost stage in the membrane module and a flow rate of permeate sent through the permeate pipeline communicating with the any of the membrane units placed at a stage higher than the membrane unit placed at the lowermost stage.

12. The multi-stage submerged type membrane separation device according to claim 2, wherein each of the membrane units has a permeate pipeline communicating therewith and sending permeate having passed through the separation membrane, and
the device further comprises a flow rate control means capable of independently controlling a flow rate of permeate sent through the permeate pipeline communicating with the membrane unit placed at the lowermost stage in the membrane module and a flow rate of permeate sent through the permeate pipeline communicating with the any of the membrane units placed at a stage higher than the membrane unit placed at the lowermost stage.

13. The multi-stage submerged type membrane separation device according to claim 3, wherein each of the membrane units has a permeate pipeline communicating therewith and sending permeate having passed through the separation membrane, and
the device further comprises a flow rate control means capable of independently controlling a flow rate of permeate sent through the permeate pipeline communicating with the membrane unit placed at the lowermost stage in the membrane module and a flow rate of permeate sent through the permeate pipeline communicating with the any of the membrane units placed at a stage higher than the membrane unit placed at the lowermost stage.

14. The multi-stage submerged type membrane separation device according to claim 4, wherein each of the membrane units has a permeate pipeline communicating therewith and sending permeate having passed through the separation membrane, and
the device further comprises a flow rate control means capable of independently controlling a flow rate of permeate sent through the permeate pipeline communicating with the membrane unit placed at the lowermost stage in the membrane module and a flow rate of permeate sent through the permeate pipeline communicating with the any of the membrane units placed at a stage higher than the membrane unit placed at the lowermost stage.

15. The multi-stage submerged type membrane separation device according to claim 5, wherein each of the membrane units has a permeate pipeline communicating therewith and sending permeate having passed through the separation membrane, and
the device further comprises a flow rate control means capable of independently controlling a flow rate of permeate sent through the permeate pipeline communicating with the membrane unit placed at the lowermost stage in the membrane module and a flow rate of permeate sent through the permeate pipeline communicating with the any of the membrane units placed at a stage higher than the membrane unit placed at the lowermost stage.

16. A membrane separation method using a multi-stage submerged type membrane separation device which comprises: a membrane module having a plurality of membrane units stacked vertically in stages, in each of which a plurality of flat sheet membrane elements each having a sheet-shaped separation membrane are arranged; a water-to-be-treated storage tank in which water to be treated is stored and the membrane module is placed in a state of being submerged in the water to be treated; and an air diffuser installed beneath the membrane module, in which the membrane unit placed at the lowermost stage is higher in sludge-filtration resistance or pure-water permeation resistance than any of the membrane units placed at stages higher than the membrane unit placed at the lowermost stage.

17. The membrane separation method according to claim 16, wherein a flow rate of permeate passing through the separation membrane of the membrane unit placed at the lowermost stage in the membrane module is controlled so as to become lower than a flow rate of permeate passing through the separation membrane of the any of the membrane units placed at a stage higher than the membrane unit placed at the lowermost stage, and controlled so that a difference between these flow rates becomes 10% or below.
